(19) United States
(12) Patent Application Publication
(10) Pub. No.: US 2016/0231550 A1
(43) Pub. Date: Aug. 11, 2016

(54) ILLUMINATOR FOR MULTI-FOCUS CONFOCAL IMAGING AND OPTIMIZED FILLING OF A SPATIAL LIGHT MODULATOR FOR MICROSCOPY

(71) Applicant: INTELLIGENT IMAGING INNOVATIONS, INC., Denver, CO (US)

(72) Inventor: Glen Ivan REDFORD, Arvada, CO (US)

(21) Appl. No.: 15/015,494

(22) Filed: Feb. 4, 2016

Related U.S. Application Data
(60) Provisional application No. 62/113,083, filed on Feb. 6, 2015.

(51) Int. Cl. G02B 21/00; G02B 27/00; G02B 3/04; G02B 27/09; G02B 5/32

(52) U.S. Cl. CPC G02B 21/0032; G02B 27/0927; G02B 5/32; G02B 3/04; G02B 27/0025; G02B 27/0037; G02B 27/0068

(57) ABSTRACT

One exemplary aspect relates to an optical system for illuminating a multi-focus confocal imager. This new illuminator has benefits such as improved throughput and field flatness. This is particularly useful in spinning-disc confocal imagers. A second aspect relates to an optical system filling the pixel array on a spatial light modulator (SLM). Throughput of the illumination light is greatly improved, and all of the pixels are illuminated uniformly. This device will then generate an optimized hologram for photo-manipulation of multiple regions simultaneously. This device is particularly useful for optical stimulation deeper into living tissue. One advantage is the improved resolution and quality of the hologram.

### RELATED APPLICATION DATA

This application claims the benefit of and priority under 35 U.S.C. §119(e) to U.S. Patent Application No. 62/113,083, filed Feb. 6, 2015, entitled “Improved Illuminator for Multi-focus Confocal Imaging/Optimized Filling Of A Spatial Light Modulator For Microscopy,” which is incorporated herein by reference in its entirety.

### BACKGROUND

Confocal microscopy is a popular technique in biology and medicine for generating optically sectioned images. A spinning disk confocal imager uses a multitude of pinholes which are focused onto the sample and then scanned over the sample to generate a complete image. Spinning disk confocal imagers are fast, robust and a vital tool for much of microscopy.

As the pinholes are scanned across the sample, they move in and out of the area that is being imaged. This area is projected to the detector (usually a digital camera) where the individual sweeps of the pinholes are integrated until the entire image is formed. As the illumination light must also pass through the pinholes, a field of excitation light is generated at the pinholes. In the case of multi-disc systems, the field can be at an array of microlenses which project the field through the pinholes. In either case, the illumination field is then projected to the sample. It is desirable to have the field be flat or uniform across the field and to have it not extend beyond the area being imaged.

U.S. Pat. No. 9,134,519 to Berman, which is incorporated herein by reference in its entirety, discloses a multi-mode fiber optically coupling a radiation source module to a multi-focal confocal microscope. A multi-mode optical fiber delivers light from a radiation source to a multi-focal confocal microscope with reasonable efficiency. A core diameter of the multi-mode fiber is selected such that an etendue of light emitted from the fiber is not substantially greater than a total etendue of light passing through a plurality of pinholes in a pinhole array of the multi-focal confocal microscope. The core diameter may be selected taking into account a specific optical geometry of the multi-focal confocal microscope, including pinhole diameter and focal lengths of relevant optical elements. For coherent radiation sources, phase randomization may be included. A multi-mode fiber enables the use of a variety of radiation sources and wavelengths in a multi-focal confocal microscope, since the coupling of the radiation source to the multi-mode fiber is less sensitive to mechanical and temperature influences than coupling the radiation source to a single mode fiber.

U.S. Pat. No. 8,922,887 to Cooper, which is incorporated herein by reference in its entirety, discloses imaging a distal end of a multimode fiber. Where a multimode fiber is used for light delivery in a microscope system and a transverse distribution of light exiting a distal end of the fiber is substantially uniform, the distal end is imaged onto a plane of a sample to be probed by the microscope system, or at a conjugate plane. Alternatively, the distal end is imaged onto a plane sufficiently close to the sample plane or the conjugate plane such that a radiant intensity of light at the sample plane or the conjugate plane is substantially uniform. In the case of a multi-focal confocal microscope system, the distal end of the multimode fiber is imaged onto a plane of a segmented focusing array. Alternatively the distal end is imaged onto a plane sufficiently close to the segmented focusing array plane such that a radiant intensity of the light at the segmented focusing array plane is substantially uniform.

EP Publication 1538470, which is incorporated herein by reference in its entirety, is entitled confocal microscope and relates to improvement in light-using efficiency in a confocal microscope incorporating a confocal laser scanner which rotates a Nipkow disk (3) at high speed together with microlenses. In an embodiment of the present invention, a beam splitter (4,12) is inserted and placed between two integrated disks (2,3), in each of which a plurality of microlenses and minute openings are arranged with the same pattern making an array respectively. This beam splitter must be of a plate type. In addition, the axis of the incident light is tilted by a significant angle to the vertical incident axis of the microlens. This cancels the light axis shift generated by a plate beam splitter and enables the incident light to the relevant microlens to be focused to the corresponding minute opening.

Recently spatial light modulators (SLMs) have been introduced as a tool for microscopy for selective photo-manipulation. This is important for studies of protein trafficking, drug delivery, and protein association. SLMs have become very important in the field of optogenetics where selective simultaneous stimulation is desired for studies of live brain activity. SLMs have the advantage of other technologies in that they can deliver large amounts of optical power simultaneously to several regions even at different depths.

A SLM works by changing a beam of light such that the phase of each part of the beam of light is digitally altered. That is, a SLM has an array of pixels that can be used to change the relative phase of the light that hits that pixel as opposed to its neighbors. After the change, an analyzer can be used to convert the beam of light into an image as formed on the SLM, but even more powerfully, the beam can be focused to create a real image that is the transform of the image on the SLM. This digital hologram can be used to generate a 3D pattern of choice on the sample.

The resolution, effective area, and accuracy of the 3D pattern generated are dependent on the number of pixels. Ideally the coherent light source impinges upon the entire array of pixels uniformly, but in practice a Gaussian beam is usually expanded to cover the array. This has two drawbacks: the illumination is not uniform over the pixel array, and illumination light is lost that hits outside of the pixel array.

The technology disclosed herein can be viewed in relation to the following patents (both of which are incorporated by reference in their entirety):
1) U.S. Pat. No. 4,818,983—A Optical image generator having a spatial light modulator and a display device
2) U.S. 2014/0295413—Systems, methods, and workflows for optogenetics analysis

Patent 1) contains a description of a spatial light modulator and Patent Application 2) describes an important use of a spatial light modulator for optogenetics.

### FIELD

An exemplary embodiment generally relates to confocal imaging in optical microscopes. More specifically, an exemplary embodiment relates to the illumination optics in a confocal scanning unit. Even more specifically, an exemplary embodiment relates to a high-efficiency flat-field illuminator for a spinning disc confocal imager.

Another exemplary embodiment generally relates to photo-manipulation in microscopes. More specifically, an exemplary embodiment relates to using a spatial light modulator (SLM) as a photo-manipulation device. Even more specifically, an exemplary embodiment relates to a high-efficiency flat-field illuminator for a SLM based photo-manipulation device.

### SUMMARY

An exemplary illumination system for a multi-focus confocal unit would have one or more of the following exemplary and non-limiting goals or ideals:
Flat or uniform illumination across the field.
No stray illumination beyond the field being imaged.
Maximum efficiency of the input light into the field.
The shape of the field is the shape of the detector.
The illuminator maintains these ideals for many different wavelengths of illumination light.

Typically an illuminator comprises an expanded beam that illuminates the field. The profile of the beam is Gaussian, so it is necessary to over-expand the beam and then crop it to match the shape of the sensor. This results in a large loss of light and a field that is never quite uniform.

With current technology an aspherical element can be added to the beam path to change it from a Gaussian profile to something more uniform (flat-top). The simplest of these elements would be an aspheric lens that shapes the beam to a circular beam with a flat top. This in general improves the illuminator but the illumination field must still be cropped to match the shape of the sensor.

Some of these elements can also shape the round beam to something rectilinear to match the sensor. A holographic element could be added which changes the phase of different parts of the beam such that when the real image is formed, it is a uniform rectilinear shape. Most confocal units would require a collimated beam at the illumination field and so the holographic element would instead be required to generate the transform of the desired beam profile. This can be problematic. Also many holographic elements are currently wavelength dependent and so there would be difficulty using them in a multiple wavelength system. Holographic units also typically suffer from bright spots or speckle in the image they produce.

Recent technology allows the creation of an aspherical optical element that will generate a uniform rectilinear beam. This element uses a complex shape to redirect the light beam. These units can be made achromatic, so they will work well with several wavelengths or a wavelength range. By using one of these optical elements, one can create a near-ideal imager. All of the input light is redirected to generate a field of illumination that is uniform and has the right shape without cropping. Diffractive optical elements also can be made to be achromatic and so are useful for making a confocal illuminator.

Unfortunately, the phase profile of the now rectilinear, uniform beam is no longer uniform across the beam after use of such a device. A second diffractive optical element(s) can be needed to fix the phase uniformity. This is particularly important for a spinning-disc confocal unit, as phase changes will change the efficiency of the illumination through the field of pinholes, making the final illumination non-uniform.

Accordingly, one exemplary embodiment is directed toward an illuminator for a multi-focus confocal imager that uses one of these aspherical beam shapers.

The exemplary apparatus can comprise:
aspheric optics to shape the beam to match the shape of the detector and make the field uniform; and
one or more other optics for one or more of beam expansion, magnification, and alignment.

This exemplary apparatus when combined with a confocal scanning imager, a microscope, and a detector would provide a way to acquire confocal images.

This device has one exemplary advantage over currently available illuminators in that it has superior flatness and much superior light efficiency.

Aspects are thus directed toward confocal imaging in optical microscopes.

Still further aspects are directed toward an illumination system for a confocal imager.

Even further aspects are directed toward an improved illuminator with beam shaping optics to uniformly illuminate a field the shape of the detector.

Still further aspects are directed toward an achromatic, aspherical beam shaper for use in a confocal imager.

Still further aspects relate to an apparatus for an illuminator for a multifocus confocal imaging device including:
one or more optical elements for shaping the input beam,
means for uniformly illuminating the pinholes in the area to be imaged, and
means for shaping the illumination field to match the sensor.

The aspect above, where an optical element is an asphere lens.

The aspect above, where an optical element is a holographic diffuser.

The aspect above, where an optical element is an aspherical beam shaper.

The aspect above, where the holographic diffuser creates a shape that is the transform of the desired sensor shape.

The aspect above, where the beam shaper shapes the illumination field to match the sensor.

The aspect above, where cropping of the illumination field is not needed.

The aspect above, where a second holographic element is used to correct for phase non-uniformity introduced by the first element.

The aspect above, where the optics can be used at multiple wavelengths.

The aspect above, where the apparatus is combined with a confocal imager.

The aspect above, where the apparatus is combined with an electronic imaging device such as a camera.

The aspect above, where the apparatus is combined with a microscope.

In accordance with yet another exemplary embodiment, as the illumination of the pixel array of a spatial light modulator (SLM) becomes less uniform, the resolution and accuracy of the pattern generated degrades. Specifically, using a Gaussian illumination pattern results in the outer pixels contributing less to the hologram. These pixels are on the outside of the back aperture of the objective, and so effectively the numerical aperture (NA) of the hologram is reduced.

Typically, the Gaussian beam is over-expanded to make the field more uniform. This results in loss of illumination light which for many applications is not a concern. However, in the field of optogenetics, increasingly there is a need for multi-photon effect stimulation into deeper tissue and this increases the need for power. More power can be obtained from bigger lasers with shorter pulses, but this can be expensive. There is a need for conserving the power as much as possible.

As discussed, with current technology an aspherical element can be added to the beam path to change it from a Gaussian profile to something more uniform (flat-top). The simplest of these elements would be an aspheric lens that shapes the beam to a circular beam with a flat top. This in general improves the illuminator but the illumination field still extends beyond the pixel array and light is lost.

Some of the optical elements can also shape the round beam to something rectilinear to match the sensor. A holographic element could be added which changes the phase of different parts of the beam such that when the real image is formed, it is a uniform rectilinear shape. Most SLMs would require a collimated beam at the illumination field and so the holographic element would instead be required to generate the transform of the desired beam profile. This can be problematic. Also many holographic elements are currently wavelength dependent and so there would be difficulty using them in a multiple wavelength system. Holographic units also typically suffer from bright spots or speckle in the image they produce.

Recent technology allows the creation of an aspherical diffractive optical element (DOE) that will generate a uniform rectilinear beam. This element uses a complex shape to redirect the light beam. These units can be made achromatic, so they will work well with several wavelengths or a wavelength range. By using one of these optical elements, one can create a near-ideal imager. All of the input light is redirected to generate a field of illumination that is uniform and has the right shape without cropping. Nearly 100% of the illumination light can be used and all of the pixels in the array are illuminated equally.

Use of any of these optics can change the phase profile of the illumination beam and so will disturb the resultant hologram. This phase profile is constant and so can be corrected for on the SLM. No second holographic element is needed as in the case with a confocal imager.

Accordingly, one exemplary embodiment is directed toward an illuminator for a SLM photo-manipulation device one of these DOE beam shapers.

The exemplary apparatus can comprise:
aspheric optics to shape the beam to match the shape of the SLM pixel array and make the field uniform; and
one or more other optics for one or more of beam expansion, magnification, and alignment.

This apparatus when combined with a SLM photo-manipulation device, a microscope, and a detector could provide a way to simultaneously stimulate multiple areas distinct in three dimensions.

This exemplary device has one exemplary advantage over currently available illuminators in that it has superior flatness and much superior light efficiency.

Aspects of are thus directed toward photo-manipulation in microscopy.

Still further aspects are directed toward an illumination system for a SLM photo-manipulation device.

Even further aspects are directed toward an improved illuminator with beam shaping optics to uniformly illuminate the pixel array of the SLM.

Still further aspects are directed toward an achromatic, DOE beam shaper for use in a SLM device.

Still further aspects relate to an apparatus for an illuminator for a SLM based photo-manipulation device comprising:
one or more optical elements for shaping the input beam;
means for uniformly illuminating the pixel array of the SLM; and
means for shaping the illumination field to match the pixel array.

The aspect above, where an optical element is an asphere lens.

The aspect above, where an optical element is a holographic diffuser.

The aspect above, where an optical element is an aspherical beam shaper.

The aspect above, where an optical element is a DOE.

The aspect above, where the holographic diffuser creates a shape that is the transform of the desired sensor shape.

The aspect above, where the beam shaper shapes the illumination field to match the pixel array.

The aspect above, where cropping of the illumination field is not needed.

The aspect above, where the optics can be used at multiple wavelengths.

The aspect above, where the apparatus is combined with a SLM.

The aspect above, where the apparatus is combined with a microscope.

These and other features and advantages are described and, or are apparent from, the following detailed description of the exemplary embodiments.

### BRIEF DESCRIPTION OF THE DRAWINGS

The exemplary embodiments of the invention will be described in detail, with reference to the following figures wherein:

FIG. 1 illustrates an exemplary optical system using an aspherical optic to shape the beam.

FIG. 2 illustrates the beam profile from FIG. 1 before use of the aspherical optics.

FIG. 3 illustrates the beam profile from FIG. 1 at the pinhole array after the beam shaping optics.

FIG. 4 illustrates an exemplary optical system where the diffractive optic generates the transform of the desired beam shape.

FIG. 5 illustrates an exemplary optical system for typical illumination of the SLM.

FIG. 6 illustrates an exemplary optical system for illumination of the SLM including beam shaping optics.

FIG. 7 illustrates the beam profile from FIG. 2 at the SLM.

### DETAILED DESCRIPTION

The exemplary embodiments of this invention will be described in relation to microscopes, imaging systems, and associated components. However, it should be appreciated that, in general, known components will not be described in detail and/or can be found in some of the related literature which was incorporated by reference. For purposes of explanation, numerous details are set forth in order to provide a thorough understanding of the present invention. It should be appreciated however that the present invention may be practiced in a variety of ways beyond the specific details set forth herein.

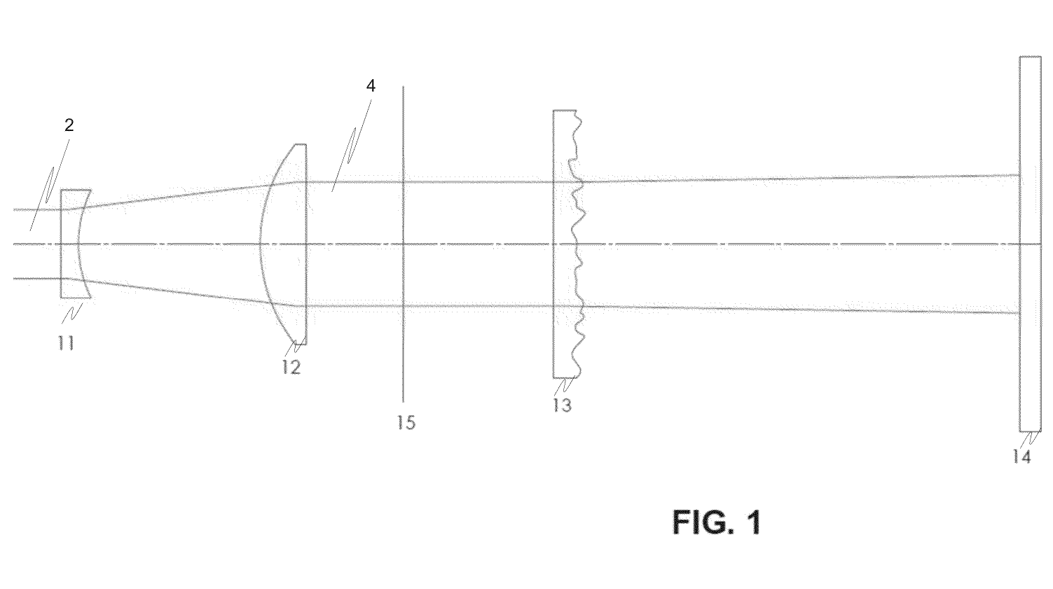

FIG. 1 illustrates an exemplary optical system that performs beam shaping on the illumination. An input beam of light (usually a laser) 2 is expanded with lens 11 and recollimated with lens 12. The expanded beam 4 then passes through the beam shaping optics 13. The beam is then sent to the pinhole array 14. Before the optical axis at plane 15 the beam has a Gaussian profile. At the pinhole array the beam has a uniform rectilinear profile to match the sensor.

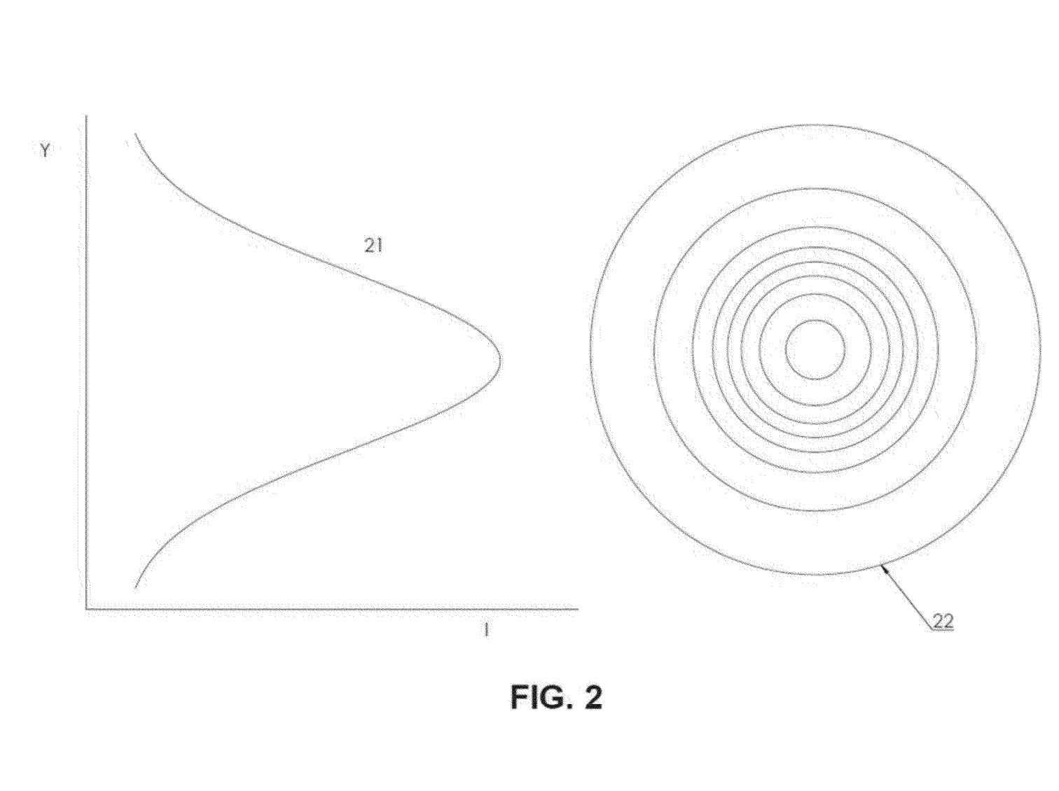

FIG. 2 illustrates the beam profile from FIG. 1 before the beam shaping optics. The profile, 21, is Gaussian and the shape, 22, is isotropic or circular.

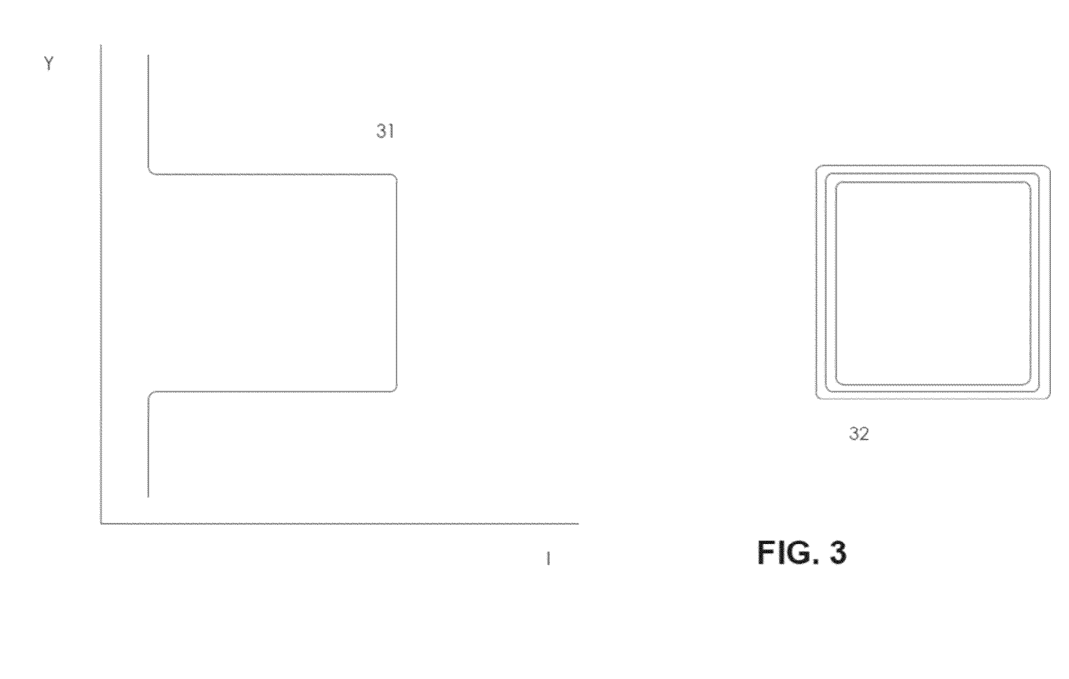

FIG. 3 illustrates the beam profile from FIG. 1 after the beam shaping optics as the beam profile is shaped at the pinhole array. The profile has a flat uniform top, 31, and the shape, 32, is rectilinear to match the detector.

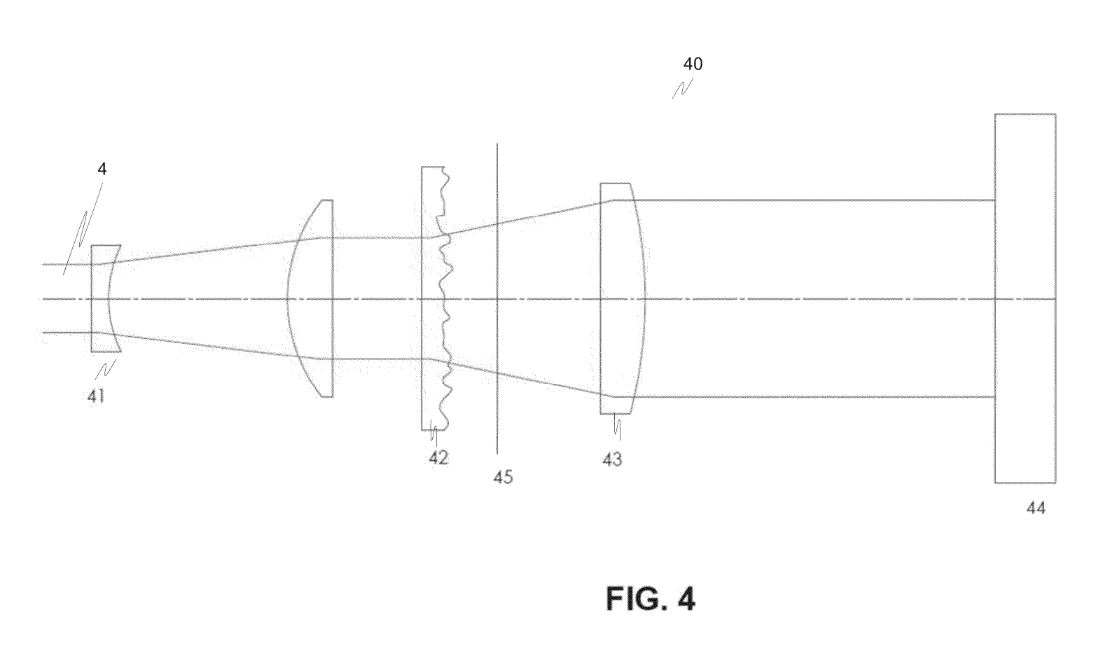

FIG. 4 illustrates an exemplary optical system 40 that performs beam shaping on the illumination. An input beam of light 4 is expended and recollimated with the optics 41. This beam then passes through the beam shaping optics 42. The beam shaping optics create a beam profile that is the transform of the desired sensor shape. After recollimating with a lens 43, the beam is now the desired uniform profile that is the shape of the sensor at the pinhole array, 44. Immediately after the beam shaping optics, 45, the profile of the beam is the Fourier transform of the desired beam shape.

It is therefore apparent that there has been provided above an exemplary illuminator for a multi-focus confocal imager. While this embodiment has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

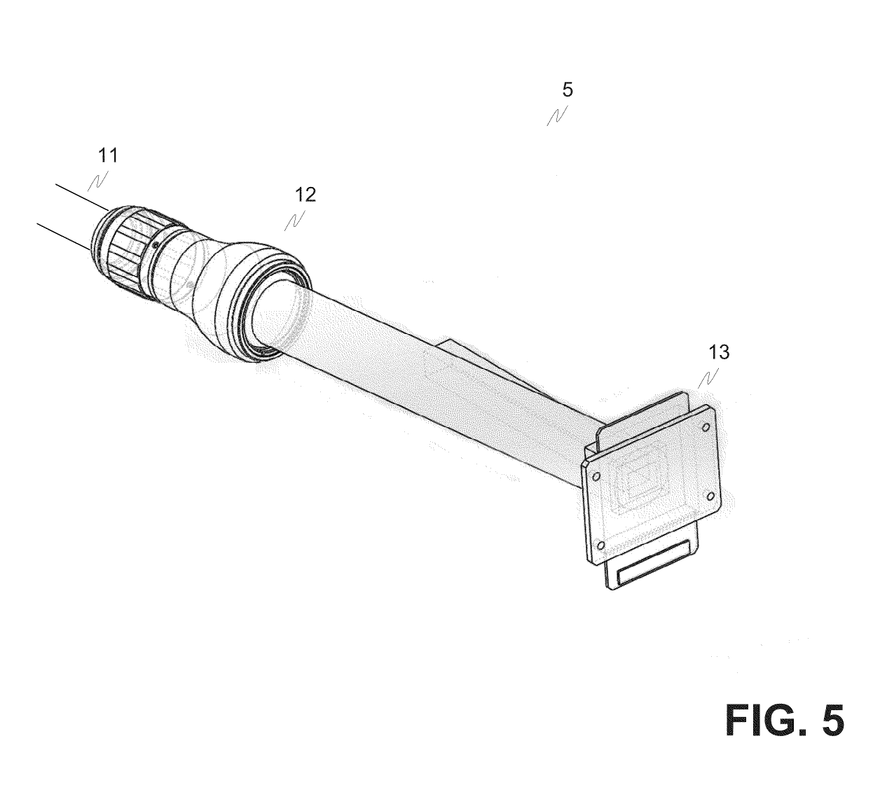

Another exemplary embodiment will now be described which also relates to microscopes, imaging systems, and associated components. FIG. 5 illustrates an exemplary optical system 5 for a typical illumination of the SLM. An input beam of light (usually a laser), 11, is expanded with 12. The expanded beam then impinges on the SLM 13. The beam at the pixel array is an over-expanded Gaussian. This results in uneven illumination of the pixels and loss of light outside of the pixel array.

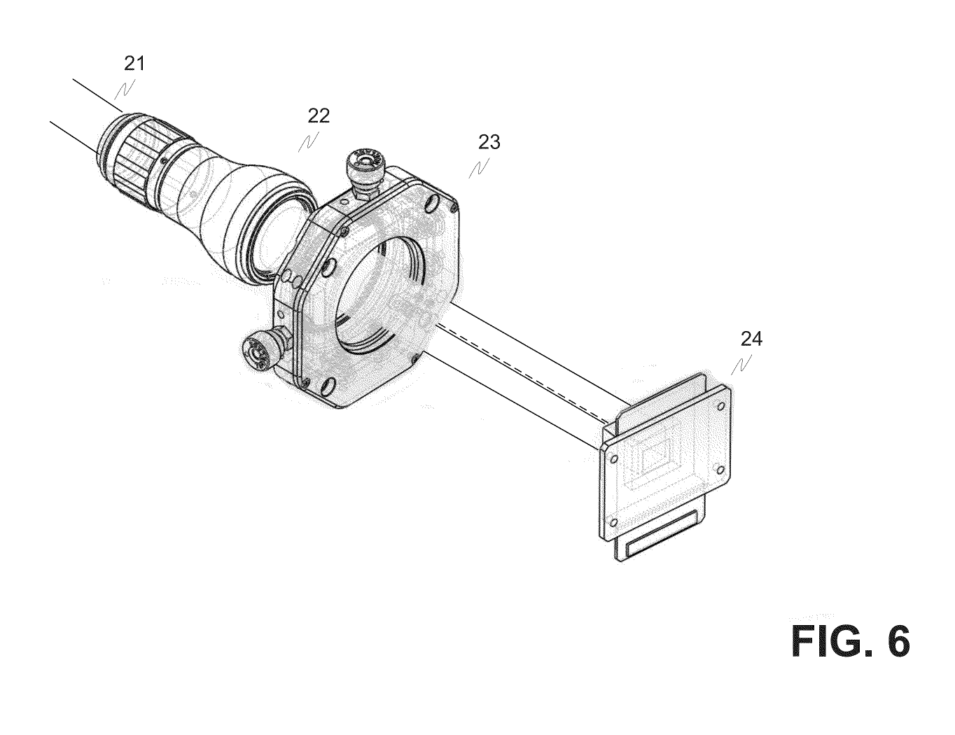

FIG. 6 illustrates an exemplary optical system for illumination of the SLM including beam shaping optics. Here, the beam 21 is expanded using element(s) 22 and then passes through the beam shaping optics 23. The beam shaping optics 23 shape the beam so that at the SLM 24 the beam is the same shape as the pixel array and uniformly illuminates all of the pixels.

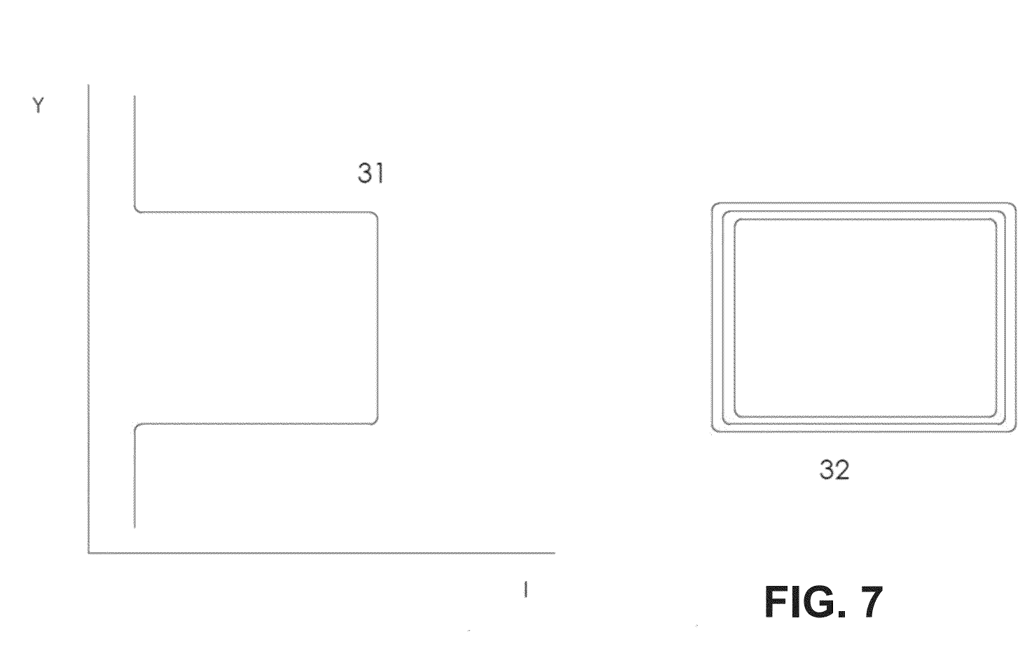

FIG. 7 illustrates the beam profile from FIG. 6 at the SLM. The beam has a uniform (flat-top) intensity across the pixel array 31. The beam also has the same shape 32 as the pixel array (i.e., rectilinear).

The exemplary techniques illustrated herein are not limited to the specifically illustrated embodiments but can also be utilized with the other exemplary embodiments and each described feature is individually and separately claimable.

The systems of this invention can cooperate and interface with a special purpose computer, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, any comparable means, or the like.

Furthermore, the disclosed control methods and graphical user interfaces may be readily implemented in software using object or object-oriented software development environments that provide portable source code that can be used on a variety of computer or workstation platforms. Alternatively, the disclosed control methods may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized.

It is therefore apparent that there has been provided, in accordance with the current embodiment an improved illuminator for an SLM based photo-manipulation device. While this aspect has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

1. An illumination system for a multi-focus confocal scanning unit comprising a plurality of optical elements including:
means to provide a uniform illumination field at the pinholes,
means to shape the illumination field to match the sensor, and
means to optimize the throughput of the illumination light.

2. The system of claim 1, wherein one of the optical elements is an aspherical optical element.

3. The system of claim 2, wherein the one optical element is a substrate, wherein one or more surfaces are shaped to change a phase of a wavefront of the illumination light to shape the collimated light beam into a non-Gaussian form.

4. The system of claim 3, wherein a shape of the collimated output from the optical element is uniform rectilinear.

5. The system of claim 1, wherein one of the optical elements is a holographic element.

6. The system of claim 5, wherein the holographic element shapes the illumination light such that creates a collimated light-beam that is non-Gaussian.

7. The system of claim 6, wherein the shape of the collimated output is uniform rectilinear.

8. The system of claim 1, wherein one of the optical elements is a diffractive optical element.

9. The system of claim 2, wherein the optical element is designed to be achromatic or to work with more than one wavelength of illumination light.

10. The system of claim 1, wherein the shape of the illumination field can be sized to match a projected shape of a detector.

11. The system of claim 1, wherein all of the input light is shaped to illuminate the field and therefore does not need to be cropped and/or a second optical element is used to correct the phase non-uniformity caused by the first optical element.

12. A system for photo-manipulation in a microscope comprising:
a spatial light modulator (SLM);
one or more optical elements that shape an illumination beam prior to the SLM;
means to provide a uniform illumination field at the pixel array of the SLM;
means to shape the illumination field to match the pixel array of the SLM; and
means to optimize throughput of the illumination beam.

13. The system of claim 12, wherein one of the optical elements is an aspherical optical element.

14. The system of claim 13, wherein the optical element is a substrate, wherein one or more surfaces are shaped to change a phase of a wavefront of the illumination beam so as to shape a collimated light beam into a non-Gaussian form.

15. The system of claim 14, wherein the shape of the collimated output from the optical element is uniform rectilinear.

16. The system of claim 12, wherein one of the optical elements is a holographic element.

17. The system of claim 16, wherein the holographic element shapes the illumination beam such that a collimated light-beam that is non-Gaussian is created.

18. The system of claim 17, wherein the shape of the output collimated light-beam is uniform rectilinear.

19. The system of claim 12, wherein one of the optical elements is a diffractive optical element.

20. The system of claim 19, wherein the optical element is designed to be achromatic or to work with more than one wavelength of illumination light.

21. The system of claim 12, wherein, the shape of the illumination field is sized to match a shape of the pixel array on the SLM.

22. The system of claim 12, wherein all of an input light is shaped to illuminate the pixel array and therefore does not need to be cropped.

23. The system of claim 12, where one or more optical elements shape the beam to be the transform of the shape of the SLM pixel array and then the beam is collimated so that at the SLM, the shape of the beam matches that of the pixel array.
